(19) United States
(12) Patent Application Publication
(10) Pub. No.: US 2014/0268299 A1
(43) Pub. Date: Sep. 18, 2014

(54) COLORED COMPOSITION AND IMAGE DISPLAY STRUCTURE

(71) Applicant: FUJIFILM CORPORATION, Tokyo (JP)

(72) Inventor: Takashi KATO, Kanagawa (JP)

(73) Assignee: FUJIFILM CORPORATION, Tokyo (JP)

(21) Appl. No.: 14/294,165

(22) Filed: Jun. 3, 2014

Related U.S. Application Data
(63) Continuation of application No. PCT/JP2012/081587, filed on Nov. 29, 2012.

(30) Foreign Application Priority Data
Dec. 15, 2011 (JP) 2011-274607

(51) Int. Cl. G02F 1/167; G02B 26/00

(52) U.S. Cl. CPC G02F 1/167; G02B 26/005; G02F 2001/1678
USPC 359/290; 252/586

(57) ABSTRACT

A colored composition includes a pyrazolone methine dye having a solubility in n-hexane of 1% by mass or higher at 25° C. and 0.1 MPa and represented by the following Formula (1), and a non-polar solvent at a content of 70% by mass or higher with respect to a total mass of the colored composition.

[chemical structure]

### CROSS-REFERENCE TO RELATED APPLICATIONS

This application is a continuation application of International Application No. PCT/JP/2012/081587, filed Nov. 29, 2012, the disclosure of which is incorporated herein by reference in its entirety. Further, this application claims priority from Japanese Patent Application No. 2011-274607, filed Dec. 15, 2011, the disclosure of which is incorporated herein by reference in its entirety.

### TECHNICAL FIELD

The present invention relates to a colored composition and an image display structure.

### BACKGROUND ART

In recent years, many organic dyes have been used in display materials, optical recording media, inkjet recording materials, etc. In a case in which a dye is used in a coating process or an inkjet recording process, the dye is required to have a high molar absorption coefficient as well as high solubility in solvents in order to increase coloring efficiency.

Recently, displays utilizing an electrowetting method (EWD) have attracted attention as a new image display technology (for example, see Nature (London), 425, 383 (2003)). Displays of this type employ an image forming method in which plural pixels filled with two phases formed by a hydrophilic medium and an oil-based color ink are arranged on a substrate, affinity for the hydrophilic medium interface or the oil-based color ink interface is controlled by on-off control of voltage application for each pixel, and image is displayed by spreading the oil-based color ink over the substrate/deforming the oil-based color ink. Dyes for use in such electrowetting displays are required to have high solubility in hydrocarbon solvents.

Dyes of many kinds are known, and, in particular, pyrazolone methine dyes have been widely used in thermal transfer. For example, various pyrazolone methine dyes having excellent light resistance and solubility, including the following compounds D-101 and D-102, have been proposed (see, for example, Japanese Patent Application Laid-Open (JP-A) Nos. 2009-66994, 2006-16564 and 2-3450).

[chemical structure]

### SUMMARY OF INVENTION

### Technical Problem

However, the pyrazolone methine dyes that have been proposed as described above do not ensure satisfactory solubility in non-polar solvents, particularly, hydrocarbon solvents such as decane or hexane. Therefore, for example, switching of image display (optical shutter) may not be properly carried out when the pyrazolone methine dyes are applied to image display utilizing the principle of electrowetting or electrophoresis. Accordingly, further improvement has been required.

The present invention aims to provide a colored composition and an image display structure, each of which contains a pyrazolone methine dye dissolved in a satisfactory dissolution state, and each of which is highly suitable for image display, particularly image display by a display device operating on the principle of electrophoresis or electrowetting (for example, on-off property at the time of image display (optical shutter property)).

### Solution to Problem

<1> A colored composition including:

a pyrazolone methine dye represented by the following Formula (1) and having a solubility in n-hexane of 1% by mass or higher at 25° C. and 0.1 MPa; and

a non-polar solvent in an amount of 70% by mass or higher with respect to the total mass of the colored composition:

[chemical structure]

wherein, in Formula (1), R¹ and R² each independently represent a hydrogen atom, a cyano group, an alkyl group, an alkoxy group, an aryl group, —COOR¹¹ or —CONR¹¹R¹²; Ar represents an aromatic ring or a saturated heterocyclic ring; R¹¹ and R¹² each independently represent a hydrogen atom, an alkyl group or an aryl group, and R¹¹ and R¹² may be linked to each other to form a 5-membered, 6-membered or 7-membered ring; R³ and R⁴ each independently represent a hydrogen atom or an alkyl group; n represents 0, 1 or 2; none of R¹ to R⁴ nor Ar has a dissociable group; and at least one selected from the group consisting of R¹, R² and Ar includes an alkyl group having from 6 to 30 carbon atoms.

<2> The colored composition according to <1>, wherein R² in Formula (1) is an alkyl group having from 6 to 30 carbon atoms, or Ar in Formula (1) includes an alkyl group having from 6 to 30 carbon atoms.

<3> The colored composition according to <1> or <2>, wherein Ar has, as a substituent, an alkylamino group in which the alkyl moiety thereof has from 6 to 30 carbon atoms.

<4> The colored composition according to any one of <1> to <3>, wherein n in Formula (1) is 1 or 2.

<5> The colored composition according to any one of <1> to <4>, wherein Ar represents a substituted or unsubstituted, 5-membered or 6-membered, aromatic ring or saturated heterocyclic ring.

<6> The colored composition according to any one of <1> to <5>, wherein Ar represents a 5-membered or 6-membered, aromatic ring or saturated heterocyclic ring, each of which is substituted by at least one substituent selected from the group consisting of an alkyl group, an alkoxy group, an aryl group and a substituted amino group.

<7> The colored composition according to any one of <1> to <6>, wherein Ar represents a benzene ring, a naphthalene ring, a pyrrole ring, an indole ring, a pyridine ring, a quinoline ring, a pyrazine ring, a quinoxaline ring, a thiazole ring, a thiazoline ring, an oxazole ring, an oxazoline ring, an imidazole ring, an imidazoline ring, a pyrrolidine ring, a tetrahydrofuran ring or a tetrahydrothiophene ring, each of which is substituted by at least one substituent selected from the group consisting of an alkyl group, an alkoxy group, an aryl group and a substituted amino group.

<8> The colored composition according to any one of <1> to <7>, wherein Ar represents a benzene ring, a pyrrole ring or an indole ring, each of which is substituted by an alkylamino group having from 6 to 30 carbon atoms in its alkyl moiety.

<9> The colored composition according to any one of <1> to <8>, wherein the viscosity of the colored composition at 20° C. is from 0.01 mPa·s to 10 mPa·s.

<10> The colored composition according to any one of <1> to <9>, which is used for production of an optical shutter layer of a display device that operates on the principle of electrowetting.

<11> The colored composition according to any one of <1> to <9>, which is used for production of a color filter of a display device that operates on the principle of electrophoresis.

<12> The colored composition according to any one of <1> to <11>, wherein the non-polar solvent includes an aliphatic hydrocarbon solvent having from 6 to 30 carbon atoms.

<13> The colored composition according to any one of <1> to <12>, wherein the non-polar solvent includes at least one selected from the group consisting of n-decane, n-dodecane, n-tetradecane and n-hexadecane.

<14> The colored composition according to any one of <1> to <13>, wherein the content of the pyrazolone methine dye is 10% by mass or higher with respect to the total mass of the colored composition.

<15> An image display structure including:

a hydrophobic polymer layer having a hydrophobic surface;

an oil layer arranged to contact the surface of the hydrophobic polymer layer and formed using the colored composition of any one of <1> to <14>; and

a hydrophilic liquid layer arranged to contact the oil layer.

In the invention, the pyrazolone methine dye represented by Formula (1) does not have any dissociable group (except for, if desired, NH), such as —SO₃H, —PO₃H₂, —CO₂H or —OH, in a molecule thereof, and easily dissolves in a non-polar solvent. Therefore, a colored composition can be prepared by dissolving the pyrazolone methine dye in a non-polar solvent.

Specifically, the pyrazolone methine dye represented by Formula (1) has excellent solubility in a non-polar solvent since the pyrazolone methine dye has a long-chain alkyl group or branched alkyl group having from 6 to 30 carbon atoms. We presume that the reason for the improved miscibility with the non-polar solvent is that the pyrazolone methine dye represented by Formula (1) has an SP value (solubility parameter) close to the SP value of the non-polar solvent used in the invention. We also presume that the low solubility of D-101 and D-102 is due to the difference between the SP value of D-101 and the SP value of the solvent and the difference between the SP value of D-102 and the SP value of the solvent.

The alkyl group contained in the molecule of the pyrazolone methine dye represented by Formula (1) is preferably a linear or branched alkyl group having from 6 to 25 carbon atoms, more preferably from 7 to 20 carbon atoms.

### Advantageous Effects of Invention

According to the invention, a colored composition and an image display structure are provided, each of which contains a pyrazolone methine dye dissolved in a satisfactory dissolution state, and each of which is highly suitable for image display, particularly, image display by a display device operating on the principle of electrophoresis or electrowetting (for example, on-off property at the time of image display (optical shutter property)).

### BRIEF DESCRIPTION OF THE DRAWING

FIG. 1 is a schematic cross-sectional view showing a configuration example of a display device operating on the principle of electrowetting.

### DESCRIPTION OF EMBODIMENTS

Colored Composition

The colored composition of the invention includes a pyrazolone methine dye represented by the following Formula (1) that has solubility in n-hexane of 1% by mass or higher at 25° C. and 0.1 MPa, and a non-polar solvent. Further, the colored composition of the invention may further include another component, such as a dye other than the pyrazolone methine dye or a polar solvent, if necessary.

Pyrazolone methine dyes are widely known from the past, and have been used for imaging purpose, for example, in the field of thermal transfer. However, conventional pyrazolone methine dyes have low solubility in non-polar solvents, and have yet to be generally used as colorants for liquid compositions formed using non-polar solvents.

In the present invention, a pyrazolone methine dye having a specified structure that includes an alkyl group having 6 or more carbon atoms is employed as a colorant of a colored composition formed using a non-polar solvent. The dye maintains its high solubility in the composition with decreased tendency toward precipitation, whereby image display (particularly, image display on display devices operating on the principle of electrophoresis or display devices operating on the principle of electrowetting) is improved. In particular, the color composition exhibits excellent on-off switching property (optical-shutter property) when displaying an image, and, therefore, enables displaying of a vivid image having excellent hue.

Pyrazolone Methine Dye

In the colored composition of the invention, the pyrazolone methine dye represented by the following Formula (1) has a solubility in n-hexane of 1% by mass or higher at 25° C. and 0.1 MPa.

Since this pyrazolone methine dye has excellent solubility in non-polar solvents, the pyrazolone methine dye is useful as a dye used for displays etc., particularly, for display devices that operates on the principle of electrophoresis or display devices that operate on the principle of electrowetting.

Hereinbelow, the pyrazolone methine dye represented by Formula (1) is described in detail.

[chemical structure]

In Formula (1), R¹ and R² each independently represent a hydrogen atom, a cyano atom, an alkyl group, an alkoxy group, an aryl group, —COOR¹¹ or —CONR¹¹R¹². Ar represents an aromatic ring or a saturated heterocyclic ring. R¹¹ and R¹² each independently represent a hydrogen atom, an alkyl group or an aryl group. R¹¹ and R¹² may be linked to each other to form a 5-membered, 6-membered or 7-membered ring. R³ and R⁴ each independently represent a hydrogen atom or an alkyl group. n represents 0, 1 or 2. None of R¹ to R⁴ nor Ar has a dissociable group. At least one selected from the group consisting of R¹ R² and Ar includes an alkyl group having from 6 to 30 carbon atoms.

In Formula (1), the alkyl group represented by R¹ or R² may have a substituent, and is preferably an alkyl group having from 1 to 30 carbon atoms. Specific examples of the alkyl group include a methyl group, an ethyl group, an i-propyl group, an n-butyl group, a tert-butyl group, a 1-methylcyclopropyl group, an n-hexyl group, a 3-heptyl group, an n-octyl group, a 2-ethylhexyl group, an n-nonyl group, an n-undecyl group, a chloromethyl group, a trifluoromethyl group, an ethoxycarbonylmethyl group and a perfluoroalkyl group (such as a perfluoromethyl group). More particularly, alkyl groups having from 6 to 30 carbon atoms are preferable, examples of which include an n-hexyl group, an n-octyl group, a 2-ethylhexyl group and a 2-methylhexyl group.

The alkoxy group represented by R¹ or R² may have a substituent, and is preferably an alkoxy group having from 1 to 30 carbon atoms. Specific examples thereof include a methoxy group, an ethoxy group, an n-butoxy group, a tert-butoxy group, a 3-heptyloxy group, an n-nonyloxy group, an n-undecyloxy group, a chloromethoxy group, a trifluoromethoxy group, an ethoxycarbonylmethoxy group and a perfluoroalkyloxy group (such as a perfluoromethoxy group). Among these, a methoxy group and an ethoxy group are preferable.

The aryl group represented by R¹ or R² may have a substituent, and is preferably an aryl group having from 6 to 36 carbon atoms. Specific examples thereof include a phenyl group, a 2,6-dimethylphenyl group, a 4-methoxyphenyl group, a 4-dibutylaminophenyl group, a 4-(2-ethylhexyloxy)phenyl group and a 4-hexylphenyl group.

In Formula (1), the alkyl group represented by R¹¹ or R¹² may have a substituent, and is preferably an alkyl group having from 1 to 30 carbon atoms. Specific examples thereof include a methyl group, an ethyl group, an ethoxycarbonylmethyl group, an n-hexyl group, an n-octyl group, a 2-ethylhexyl group, a dodecyl group, a cyclohexyl group, a cyanoethyl group, a 2,2,3,3-tetrafluoropropyl group, a chloroethyl group, an acetoxyethyl group and a dimethylaminomethyl group.

The aryl group represented by R¹¹ or R¹² may have a substituent, and is preferably an aryl group having from 6 to 36 carbon atoms. Specific examples thereof include a phenyl group, a 4-methylphenyl group, a 4-ethylphenyl group, a 4-methoxyphenyl group, a 4-(2-ethylhexyloxy)phenyl group and a 4-dodecyloxyphenyl group. The 5-membered, 6-membered or 7-memberd ring formed by mutual linking of R¹¹ and R¹² is a 5-membered, 6-membered or 7-memberd ring containing an N atom, and preferable examples thereof include a pyrrolidine ring, a piperidine ring, a morpholine ring, a piperazine ring and a hexamethyleneimine ring. The 5-membered, 6-membered or 7-memberd ring may have a substituent.

The aromatic ring or saturated heterocyclic ring represented by Ar is preferably a 5- or 6-memberd ring, and specific examples thereof include aromatic rings such as a benzene ring, a naphthalene ring, a pyrrole ring, an indole ring, a pyridine ring, a quinoline ring, a pyrazine ring, a quinoxaline ring, a thiazole ring, a thiazoline ring, an oxazole ring, an oxazoline ring, an imidazole ring and an imidazoline ring; and saturated heterocyclic rings such as a pyrrolidine ring, a tetrahydrofuran ring and a tetrahydrothiophene ring. Among these, a benzene ring, a pyrrole ring and an indole ring are preferable.

The aromatic or saturated heterocyclic ring represented by Ar may be unsubstituted or substituted. When the aromatic or saturated heterocyclic ring represented by Ar is substituted, the substituent may be appropriately selected from substituents other than dissociable groups. Specific examples of the substituent include an alkyl group, an alkoxy group, an aryl group and a substituted amino group.

The alkyl group, the alkoxy group, and the aryl group as substituents have the same definitions as the alkyl group, the alkoxy group and the aryl group for R¹ or R² above, respectively, and preferable embodiments thereof are also the same.

The substituted amino group as a substituent is preferably an alkylamino group, and more preferably an alkylamino group having from 6 to 30 carbon atoms (preferably from 7 to 20 carbon atoms) in the alkyl moiety thereof. The alkylamino group is preferably a dialkylamino group, and more preferably a dialkylamino group in which at least one of the two alkyl groups thereof has from 6 to 30 carbon atoms (preferably from 7 to 20 carbon atoms), and still more preferably a dialkylamino group in which each of the two alkyl groups thereof has from 6 to 30 carbon atoms (preferably from 7 to 20 carbon atoms).

Among these, when the aromatic or saturated heterocyclic ring represented by Ar has a substituent, the substituent is preferably an alkyl group, an alkylamino group having from 6 to 30 carbon atoms (preferably 7 to 20 carbon atoms) in the alkyl moiety thereof, or an alkoxy group.

None of R¹ to R⁴ nor Ar contains a dissociable group (except for, if desired, NH).

R³ and R⁴ each independently represent a hydrogen atom or alkyl group. Examples of the alkyl group represented by R³ or R⁴ include an alkyl group having from 1 to 10 carbon atoms such as a methyl group, an ethyl group, a propyl group, a butyl group or a 2-ethylhexyl group. R³ and R⁴ each preferably represent a hydrogen atom.

n represents 0, 1 or 2, and preferably represents 0 or 1.

At least one selected from the group consisting of R¹, R² and Ar includes an alkyl group having from 6 to 30 carbon atoms. It is preferable that R² is an alkyl group having from 6 to 30 carbon atoms, or that Ar includes an alkyl group having from 6 to 30 carbon atoms. It is also preferable that Ar includes, as a substituent, an alkylamino group having from 6 to 30 carbon atoms in the alkyl moiety thereof.

Specific examples of the pyrazolone methine dye represented by Formula (1) are shown below. However, the invention is not limited thereto.

Here, in the structures shown below, “Me” represents a methyl group, “Et” represents an ethyl group, “n-Pr” represents a normal propyl group, “i-Pr” represents an iso-propyl group, “n-Bu” and simple “Bu” each represent a normal butyl group, “t-Bu” represents a tert-butyl group, and “Ph” represents a phenyl group. In addition, “C₈H₁₇” in compound D-13 represents a normal octyl group.

[chemical structure]

| Number | R¹ | R² | R⁵ | R⁶ | R⁷ |
|---|---|---|---|---|---|
| D-1 | Me | Me | H | n-C₈H₁₇ | n-C₈H₁₇ |
| D-2 | t-Bu | i-Pr | Me | n-C₈H₁₇ | n-C₈H₁₇ |
| D-3 | EtO | C₆H₁₃ | MeO | n-C₈H₁₇ | n-C₈H₁₇ |
| D-4 | i-Pr | Ph | Et | n-C₁₀H₂₁ | n-C₁₀H₂₁ |
| D-5 | Me | n-C₈H₁₇ | ET1 | Et | Et |
| D-6 | n-C₈H₁₇ | t-Bu | H | Et | Et |
| D-7 | CN | CF₃ | n-C₈H₁₇O | n-Bu | n-Bu |
| D-8 | CN | Ph | i-Pr | n-C₈H₁₇ | n-C₈H₁₇ |
| D-9 | CF₃ | CH₂CHEt—C₄H₉ | ET2 | n-Bu | n-Bu |
| D-10 | CO₂Et | 2,6-Me₂—Ph | CF₃O | n-C₈H₁₇ | n-C₈H₁₇ |
| D-11 | CO₂C₆H₁₃ | Ph | Me | n-C₆H₁₃ | n-C₆H₁₃ |

“ET-1” in compound D-5 and “ET-2” in compound D-9 represent the groups shown below, respectively. Each of the wavy lines in ET-1 and ET-2 represents a bonding site (a site at which R⁵ binds to the benzene ring).

[chemical structure]

[chemical structure]

[chemical structure]

| Number | R¹ | R² | R⁵ | R⁶ | R⁷ | n |
|---|---|---|---|---|---|---|
| E-1 | Me | Me | H | n-C₈H₁₇ | n-C₈H₁₇ | 1 |
| E-2 | CN | t-Bu | Me | n-C₈H₁₇ | n-C₈H₁₇ | 1 |
| E-3 | CO₂Et | i-Pr | MeO | n-C₁₀H₂₁ | n-C₁₀H₂₁ | 1 |
| E-4 | t-Bu | t-Bu | ET2 | Et | Et | 1 |
| E-5 | i-Pr | n-Bu | MeO | n-C₈H₁₇ | n-C₈H₁₇ | 2 |
| E-6 | t-Bu | n-C₈H₁₇ | n-C₈H₁₇O | n-C₈H₁₇ | n-C₈H₁₇ | 2 |
| E-7 | CN | Ph | n-C₈H₁₇O | Et | Et | 2 |

[chemical structure]

The pyrazolone methine dye including an alkyl group having from 6 to 30 carbon atoms in its molecule can be synthesized based on methods such as those described in JP-A Nos. 2008-248123, 2-3450 and 49-114420.

The pyrazolone methine dye can also be produced by known synthesis processes such as those described in Japanese Patent No. 2707317, and JP-A Nos. 5-45789, 2009-263517 and 3-72340.

In one embodiment, the colored composition of the invention includes only one pyrazolone methine dye represented by Formula (1). In another embodiment, the colored composition of the invention includes two or more pyrazolone methine dyes represented by Formula (1). When the colored composition of the invention includes two or more pyrazolone methine dyes represented by Formula (1), the ratio therebetween may freely be selected.

The content of the pyrazolone methine dye represented by Formula (1) in the colored composition is not specifically limited, and the pyrazolone methine dye represented by Formula (1) may be prepared at any concentration in accordance with the purpose. From the viewpoint of hue, the content of the pyrazolone methine dye represented by Formula (1) in the colored composition is preferably 10% by mass or higher with respect to the total mass of the colored composition. From the viewpoints of hue and color density, it is more preferable that the colored composition contains the pyrazolone methine dye at a higher content. More specifically, for similar reasons, the content of the pyrazolone methine dye represented by Formula (1) in the colored composition is preferably 15% by mass or higher, more preferably 20% by mass or higher, and still more preferably 25% by mass or higher, with respect to the total mass of the colored composition. With a view to achieving a low viscosity of the colored composition, the content of the pyrazolone methine dye represented by Formula (1) in the colored composition is preferably 20% by mass or higher. Regarding the upper limit, the content of the pyrazolone methine dye represented by Formula (1) in the colored composition may be 80% by mass or lower.

Solubility of Pyrazolone Methine Dye

The pyrazolone methine dye represented by Formula (1) has good solubility in non-polar solvents, particularly in hydrocarbon solvents, and has solubility in n-hexane of 1% by mass or higher at 25° C. and 0.1 MPa. A solubility in n-hexane of 1% by mass or higher indicates that the pyrazolone methine dye can be used in materials (for example, color filters) for producing displays that operates on the principle of electrowetting or electrophoresis.

Hereinbelow, the solubility of the dye in n-hexane at 25° C. and 0.1 MPa is sometimes simply referred to as “solubility”.

In a case in which the pyrazolone methine dye according to the invention is used in an image display material for producing a display that operates on the principle of electrowetting or for producing a display that operates on the principle of electrophoresis (for example, in a display member such as an image display structure such as (i) an optical-shutter for switching the on-off states (image displaying/non-displaying states) of pixels or (ii) a color display layer (color filter) of a display device that operates on the principle of electrophoresis), the solubility the pyrazolone methine dye is preferably 3% by mass or higher, and more preferably 5% by mass or higher. A higher solubility is more preferable. Nevertheless, the solubility the pyrazolone methine dye is usually about 80% by mass or lower.

Other Dyes

The pyrazolone methine dye represented by Formula (1) may be the only dye contained in the colored composition of the invention. Alternatively, the colored composition of the invention may further include a dye other than the pyrazolone methine dye, in order to obtain an intended hue. For example, the pyrazolone methine dye according to the invention may be mixed with a red dye and/or a blue dye, each of which has a structure different from that of the pyrazolone methine dye, to form a black composition.

The dye having a structure different from that of the pyrazolone methine dye, which may be optionally contained in the colored composition of the invention, may be freely selected from dyes having sufficient solubility or dispersibility in the non-polar solvent to be employed, as long as the effects of the pyrazolone methine dye are not impaired.

In a case in which the colored composition of the invention is used for electrowetting displays, the dye, other than the pyrazolone methine dye, that is optionally contained in the colored composition of the invention may be freely selected from dyes that dissolve in non-polar solvents such as aliphatic hydrocarbon solvents. Specific examples thereof include Oil Blue N (alkylamine-substituted anthraquinone), Solvent Green, Sudan Red and Sudan Black.

Non-Polar Solvent

The colored composition of the invention includes at least one non-polar solvent. Here, non-polar solvent means a solvent having low dielectric constant (so-called apolar solvent).

The non-polar solvent as employed in the invention is a solvent that dissolves the above-described pyrazolone methine dye, and specific examples thereof include aliphatic hydrocarbon solvents (preferably having from 6 to 30 carbon atoms) such as n-hexane, n-decane, n-dodecane, n-tetradecane and n-hexadecane.

The colored composition of the invention includes a non-polar solvent, and may further include a solvent other than non-polar solvents, to the extent that the effects of the present invention are not impaired.

In the invention, the content of non-polar solvent in the colored composition of the invention is preferably 70% by mass of higher, more preferably 90% by mass of higher, with respect to the total solvent amount in the colored composition. When the content of non-polar solvent in the colored composition is 70% by mass of higher, the solubility of the pyrazolone methine dye is maintained in a more favorable manner, and an excellent optical-shutter property and excellent display contrast can be exhibited in a case in which the colored composition of the invention is used for a display device that operates on the principle of electrophoresis or electrowetting. More preferably, the colored composition of the invention includes non-polar solvent as the only solvent component (that is, the proportion of non-polar solvent to the entire solvent contained in the colored composition is 100% by mass).

Other Components

The colored composition of the invention may further include various additives, such as ultraviolet absorbers and antioxidants, as necessary.

The content of additives is not specifically limited. Usually, additives are used in an amount of about 20% by mass or lower with respect to the total mass of the colored composition.

An ink for a display device that operates on the principle of electrowetting can be prepared by dissolving the pyrazolone methine dye according to the invention and, if necessary, other optional dyes in a non-polar solvent such as an aliphatic hydrocarbon solvent (such as those described above).

The concentration (C) of the pyrazolone methine dye according to the invention in the colored composition of the invention may be freely set in accordance with the purpose. In a case in which the pyrazolone methine dye according to the invention is used as a magenta dye for a display of a display device that operates on the principle of electrowetting, the pyrazolone methine dye according to the invention may be used in a diluted state in which the pyrazolone methine dye is diluted with a non-polar solvent to a concentration of usually 0.2% by mass or higher in accordance with the required ∈C value (∈ indicating the absorption coefficient of the colored composition).

The colored composition of the invention preferably has a dynamic viscosity at 20° C. of 10 mPa·s or lower. More specifically, the dynamic viscosity is preferably 0.01 mPa·s or higher, more preferably from 0.01 mPa·s to 8 mPa·s. A viscosity of the colored composition of 10 mPa·s or lower is highly suitable for use in image display materials for display devices that operate on the principle of electrowetting or electrophoresis, and is preferable particularly in a case in which the colored composition is used in an optical shutter for image display employing the principle of electrowetting; specifically, in such a case, a viscosity of the colored composition of 10 mPa·s or lower realizes a higher response speed and enables driving at a lower voltage, as compared with a composition having a higher viscosity.

Here, the dynamic viscosity is a value obtained by measurement at 20° C., using a viscometer (type 500, manufactured by Toki Sangyo Co., Ltd.).

The pyrazolone methine dye preferably satisfies the following condition. Specifically, the dynamic viscosity of a 5% by mass solution of the dye in n-hexane conditioned at 20° C. as measured with a viscometer (type 500, manufactured by Toki Sangyo Co., Ltd.) is preferably 10 mPa·s or lower, more preferably from 0.01 mPa·s to 10 mPa·s, and still more preferably from 0.01 mPa·s to 8 mPa·s.

The colored composition of the invention preferably has a lower dielectric constant, for example, a dielectric constant of from 2.0 to 10.0. A dielectric constant of the colored composition of the invention of from 2.0 to 10.0 is highly suitable for application to image display materials for display devices that operate on the principle of electrowetting or electrophoresis. A dielectric constant of the colored composition of from 2.0 to 10.0 is preferable particularly in a case in which the colored composition of the invention is used in an optical shutter for an image display that operates on the principle of electrowetting, since a dielectric constant within such a range realizes a higher response speed and enables driving at a lower voltage as compared with a composition having a higher dielectric constant.

The dielectric constant of the colored composition is obtained by filling the colored composition into a glass cell provided with transparent indium-tin-oxide electrodes and having a cell gap of 10 μm, and measuring the electrical capacity of the resultant cell at 20° C. and 40 RH % using a type 2353 LCR meter (manufactured by NF Corporation) at measurement frequency of 1 kHz.

Image Display Structure and Display Device

Since the pyrazolone methine dye contained in the colored composition of the invention has excellent solubility in non-polar solvents, especially, hydrocarbon solvents, the colored composition is useful as an image display material for use in display devices such as displays, more specifically, display devices (e.g., displays) that operate on the principle of electrowetting or display devices (e.g., displays) that operate on the principle of electrophoresis. Accordingly, the colored composition of the invention is highly suitable for use in the production of image display structures that perform image display in these display devices.

The principle of electrowetting is described, for example, in WO 2005/098524. This principle utilizes the phenomenon that a hydrophobic oil layer arranged on a polymer having a hydrophobic surface is deformed by application of a voltage. A hydrophobic liquid (oil droplets) and a polymeric solid (for example, a polymer layer) are in the state of being surrounded by a hydrophilic liquid (for example, water). In a display that operates on this principle, a material having a hydrophobic surface having low affinity for water is used as, for example, a substrate disposed on a side farther from the viewing face of the display, and the space between the substrate and an electrode disposed on a side nearer to the viewing face is filled with a hydrophilic liquid (for example, water) and colored oil droplets (a hydrophobic liquid), and a voltage is applied thereto. The voltage applied between the hydrophilic liquid and the electrode generates a voltage difference, and the voltage difference causes Coulomb interaction between the hydrophilic liquid and the electrode such that the hydrophilic liquid and the electrode are attracted to each other. This causes the hydrophobic liquid to deform to cover only that part of the bottom of the pixel (the part at which the voltage is not applied) rather than the entire bottom of the pixel. Preferably, the polymer layer having a hydrophobic surface is transparent, and the area from which the covering by the hydrophobic liquid is removed turns into the transparent state. The change in the shape of the hydrophobic liquid between a case in which a maximum voltage is applied and a case in which a voltage is not applied is recognized by viewers as the switching between the on- and off-states of the pixel. Displays operating on this principle include transmissive electrowetting displays and reflective electrowetting displays. In the case of the transmissive electrowetting displays, the pixel appears transparent in the on-state since oil droplets covering the hydrophobic surface of the substrate move away to allow transmission of light through the hydrophilic liquid. In the off-state, the pixel appears colored or black, thereby creating an optical image. Examples of the reflective electrowetting displays include a display in which the polymeric solid to be used has white color, and a display in which a reflective layer is disposed underneath the electrode. In the case of the reflective electrowetting display, the pixel appears white in the on-state since oil droplets covering the hydrophobic surface of the substrate move away to expose the polymeric solid, thereby allowing the white color of the polymeric solid to be observed through the hydrophilic liquid. In the off-state, the pixel appears colored or black, thereby creating an optical image.

As explained above, a compound used for coloring the oil droplets (hydrophobic liquid) is required to have high solubility in the non-polar solvent that forms the oil droplets. The colored composition of the invention, in which the pyrazolone methine dye having excellent solubility in non-polar solvents is contained, is highly suitable for display methods utilizing the electrowetting method.

More specifically, the electrowetting display preferably has an image display structure in which at least a polymer layer having a hydrophobic surface, an oil layer arranged to contact the surface of the polymer layer and formed using the colored composition of the invention, and a hydrophilic solution layer arranged to contact the oil layer are provided. An example of a display device having such an image display structure is an electrowetting device shown in FIG. 1.

As shown in FIG. 1, an electrowetting device 50 is provided with an incident surface 21a from which light enters, a light outgoing surface 21b from which light leaves and which is disposed at a side opposite to the incident surface 21a, a cell 21 closed by plural side surfaces 21c and 21d, an electrode 14 disposed within the cell 21, an insulating layer (a polymer layer) 13 disposed on the electrode 14, an oil layer 12 filled into the cell 21 and disposed to contact the insulating layer 13, a hydrophilic solution layer 11 contained in the cell 21 and disposed to contact the oil layer 12, and a power supply 25 electrically connected to the hydrophilic solution layer 11 and the electrode 14. In addition, this device is also equipped with a switch SW 26 for turning on or off the power supply 25, and a light source 27 that is disposed outside the cell 21 and that illuminates the cell 21.

Since the insulating layer 13 is formed using a hydrophobic material, the oil layer 12 contacts the surface of the insulating layer 13 when the switch SW 26 is in the off position, and separates the hydrophilic solution layer 11 and the insulating layer 13 from each other. However, when the SW 26 is switched to the on position, the electrode 14 and the hydrophilic solution layer 11 are electrically charged, as a result of which Coulomb interaction occurs therebetween. This increases the affinity between the electrode 14 and the hydrophilic solution layer 11, and the oil layer 12 moves so as to minimize its area of contact with the insulating layer 13. Here, since the oil layer 12 is formed using the above-described colored composition of the invention, the hue displayed by the device is the hue of the oil layer 12 when the switch SW 26 is in the off position, but is switched to be transparent when the switch SW 26 is switched to the on position. The hydrophilic solution layer 11 may be colored in a desired hue such as red, green or blue, in which case two-color display is possible based on the hue formed by the oil layer and the hydrophilic solution layer and the hue of the hydrophilic solution layer alone. Furthermore, color image display is possible in a case in which plural cells respectively exhibiting desired hues (for example, three primary colors of R, G and B) are arranged in a single pixel, and a voltage is selectively supplied cell by cell. The cell exhibiting each hue can be formed by appropriate selection of the combination of the hue of the hydrophilic solution layer and the hue of the oil layer. In a case in which the hue of the oil layer 12 is black, a light is shielded when the switch SW 26 is in the off position; however, when the switch SW 26 is in the on position, light emitted from the light source 27 reaches the light outgoing surface 21b to display white. In this way, black-and-white display can be realized.

Electrowetting technique in the field of displays has various advantages, such as low energy consumption and rapid switching of the pixel display state (reduction of the switching time, which is essential for movie display), as compared to other display techniques. Furthermore, since the colorant dissolved in the hydrophobic liquid imparts color to the pixel, the pixel in the display can be designed to exhibit various colors. The colorant should be substantially insoluble in the hydrophilic liquid. This technique realizes a transmissive display based on colors of red (R), green (G), blue (B) and black, or a reflective electrowetting display based on colors of cyan (C), magenta (M), yellow (Y) and black.

The strength of coulomb interaction between the electrode and the hydrophilic solution is proportional to the voltage applied. Therefore, various gray-scale colors can be displayed in the pixel depending on the applied voltage, whereby a high quality image can be generated in the display.

The electrowetting technique can be applied to optical filters, adaptive lenses, and lab-on-a-chip techniques, as well as displays.

The principle of the electrophoretic method utilizes a phenomenon that application of an electric field causes electrically charged particles dispersed in a solvent to migrate. The electrophoretic method has advantages in terms of low power consumption and being free from viewing angle dependence.

In a display that operates on the principle of electrophoresis, a dispersion liquid in which electrically charged particles are dispersed in a colored solution is arranged between two substrates that face each other. Here, the dispersion liquid serves as an image display structure that contributes to color display function, for example, a color filter. An image is displayed by applying a voltage of about several volts between the substrates to cause the particles to migrate in the liquid phase. The display may be configured to have an image display structure that contributes to color displaying (so-called color filter), and in which a dispersion liquid containing electrically charged particles dispersed in the colored composition of the invention as a colored solution is microencapsulated and disposed between two substrates that face each other. The colored composition of the invention in which the pyrazolone methine dye having excellent solubility in non-polar solvents is contained is highly suitable for display methods utilizing the electrophoretic method.

### EXAMPLES

The invention is described more specifically below by reference to examples. However, the invention is not limited to the examples, as long as the gist of the invention is retained.

### Examples 1 to 5

Each of Exemplary Compounds D-2, D-7, E-3, D-11 and D-5 shown above as dyes was individually dissolved in n-hexane as a solvent to make a 15% by mass solution, so that colored compositions of the respective exemplary compounds were prepared. Each of the obtained colored compositions was evaluated with respect to its color, absorption maximum wavelength (λ max), absorption coefficient (∈) and viscosity, and solubility (% by mass) of the dye in n-hexane, according to the following methods. The evaluation results are shown in Table 1, together with the indication of the dye (the number of the exemplary compound) used.

Evaluation Method for Each Property

1. Color of Colored Composition

The color of the colored composition was visually evaluated.

2. Absorption Maximum Wavelength and Absorption Coefficient of the Colored

### Composition

The absorption maximum wavelength (λmax) and the absorbance (abs) of the colored composition were measured using a visible-light spectrophotometer (trade name: UV-1800PC, manufactured by Shimadzu Corporation). The absorption coefficient (∈) was calculated based on the Lambert-Beer law.

3. Solubility in n-hexane

The solubility of each dye in n-hexane as a solvent was measured as follows.

The dye to be measured was dissolved in n-hexane heated at 50° C., to prepare a saturated solution. The saturated solution obtained was then left in an environment of 25° C. and 0.1 MPa for 1 hour. The precipitated dye was filtered, and the precipitation amount was measured, from which the solubility (% by mass) of the dye in n-hexane at 25° C. and 0.1 MPa was calculated.

4. Measurement of Viscosity

A 5% by mass solution of each dye in n-hexane was prepared, and the viscosity of the resultant solution was measured at 20° C. using a viscometer (type 500, manufactured by Toki Sangyo Co., Ltd.).

### Comparative Examples 1 to 3

Colored compositions of Comparative Examples 1 to 3 were prepared in the same manner as in Example 1, except that exemplary compound D-2 as a dye was replaced with the following compounds D-101, D-102 and D-103, respectively. However, since these dyes did not sufficiently dissolve, the evaluations of the resultant colored compositions with respect to its color, absorption maximum wavelength, absorption coefficient and viscosity, and the solubility of the dye could not be properly carried out. The evaluation results are shown in Table 1 together with the dyes used. Here, in the structures shown below, “Et” represents an ethyl group, “Me” represents a methyl group, “Ph” represents a phenyl group, and “Bu” represents a normal butyl group.

[chemical structure]

TABLE 1

| | | | | | | Absorption | |
|---|---|---|---|---|---|---|---|
| | Dye | | Color of | | Absorption | Maximum | |
| | Exemplary | | Colored | Solubility | Coefficient | Wavelength | Viscosity |
| | Compound | Solvent | Composition | (% by mass) | (ε) | (λ max) | (mPa · s) |
| Example 1 | D-2 | n-hexane | orange | 5.5 | 5.05 × 10⁴ | 500 nm | 1.9 |
| Example 2 | D-7 | n-hexane | red | 5.0 | 5.20 × 10⁴ | 556 nm | 1.9 |
| Example 3 | E-3 | n-hexane | red | 7.2 | 5.20 × 10⁴ | 535 nm | 1.8 |
| Example 4 | D-11 | n-hexane | orange | 1.2 | 5.10 × 10⁴ | 496 nm | — |
| Example 5 | D-5 | n-hexane | red | 7.0 | 5.05 × 10⁴ | 510 nm | 1.9 |
| Comparative | D-101 | n-hexane | not colored | 0.01 or lower | — | — | — |
| Example 1 | | | at all | | | | |
| Comparative | D-102 | n-hexane | not colored | 0.01 or lower | — | — | — |
| Example 2 | | | at all | | | | |
| Comparative | D-103 | n-hexane | hardly | 0.1 or lower | — | — | — |
| Example 3 | | | colored | | | | |

As shown in Table 1, it was demonstrated that the exemplary compounds used in Examples 1 to 5, which are pyrazolone methine dyes according to the invention, have higher solubility in hydrocarbon solvents, as compared with comparative compounds D-101, D-102 and D-103, and that the compositions obtained using the exemplary compounds according to the invention exhibited high absorption coefficients.

Accordingly, from these results, it is understood that colored composition of the invention, which includes the pyrazolone methine dye according to the invention, is highly suitable for use in the production of optical-shutters of display devices that operate on the principle of electrowetting or display devices that operate on the principle of electrophoresis.

### Example 6

### Preparation of Black Colored Composition

Pyrazolone methine dye D-2 and E-2 according to the invention as magenta dyes, the following Dye Y-1 as a yellow dye, and the following Dyes C-1 and C-2 as cyan dyes were dissolved in n-decane at the following compositional ratio, thereby preparing a colored composition.

Here, in the following structures, “t-Bu” indicates a tert-butyl group, “i-Pr” indicates an iso-propyl group, “C₈H₁₇” indicates a normal octyl group, and “C₁₂H₂₅” indicates a normal dodecyl group.

Compositional Ratio

| | |
|---|---|
| Exemplary compound D-2 | 100 mg |
| Exemplary compound E-2 | 210 mg |
| Dye Y-1 (following structure) | 190 mg |
| Dye C-1 (following structure) | 300 mg |
| Dye C-2 (following structure) | 300 mg |
| n-decane | 900 mg |

[chemical structure]

The colored composition obtained was black. The viscosity of the colored composition was measured using a viscometer, and was found to be 7.8 mPa·s. In a case in which a colored composition having low viscosity is used in an optical shutter for a display that operates on the principle of electrowetting, the optical shutter has a higher response speed and can be driven at a lower voltage, as compared with a case in which a composition having a higher viscosity is used. Accordingly, it is understood that the colored composition of the invention is highly suitable for use in optical shutters of displays that operate on the principle of electrowetting, in a case in which the colored composition is configured to have black color.

### Examples 7 to 12

A cell is prepared in which an ITO electrode (corresponding to electrode 14) and an insulating layer made of a fluoropolymer (trade name: CYTOP, manufactured by Asahi Glass Co., Ltd.) (corresponding to insulating layer 13) are sequentially arranged. Any one of the colored compositions of Examples 1 to 6 is added into the cell, and a sodium chloride aqueous solution or ethylene glycol (hydrophilic liquid) is further filled into so as to be disposed on the colored composition. In this way, an electrowetting device as shown in FIG. 1 is prepared.

The electrowetting device obtained exhibits excellent display on-off switching property (so-called optical-shutter property) when displaying an image.

### INDUSTRIAL APPLICABILITY

The colored composition of the invention is highly suitable for use in display devices such as displays, particularly, display devices that operate on the principle of electrowetting or display devices that operate on the principle of electrophoresis.

1. A colored composition comprising:
a pyrazolone methine dye represented by the following Formula (1) and having a solubility in n-hexane of 1% by mass or higher at 25° C. and 0.1 MPa; and
a non-polar solvent in an amount of 70% by mass or higher with respect to a total mass of the colored composition: [chemical structure]
wherein, in Formula (1), R¹ and R² each independently represent a hydrogen atom, a cyano group, an alkyl group, an alkoxy group, an aryl group, —COOR¹¹ or —CONR¹¹R¹²; Ar represents an aromatic ring or a saturated heterocyclic ring; R¹¹ and R¹² each independently represent a hydrogen atom, an alkyl group or an aryl group, and R¹¹ and R¹² may be linked to each other to form a 5-membered, 6-membered or 7-membered ring; R³ and R⁴ each independently represent a hydrogen atom or an alkyl group; n represents 0, 1 or 2; none of R¹ to R⁴ nor Ar has a dissociable group; and at least one selected from the group consisting of R¹, R² and Ar includes an alkyl group having from 6 to 30 carbon atoms.

2. The colored composition according to claim 1, wherein R² in Formula (1) is an alkyl group having from 6 to 30 carbon atoms, or Ar in Formula (1) includes an alkyl group having from 6 to 30 carbon atoms.

3. The colored composition according to claim 1, wherein Ar has, as a substituent, an alkylamino group in which the alkyl moiety thereof has from 6 to 30 carbon atoms.

4. The colored composition according to claim 1, wherein n in Formula (1) is 1 or 2.

5. The colored composition according to claim 1, wherein Ar represents a substituted or unsubstituted, 5-membered or 6-membered, aromatic ring or saturated heterocyclic ring.

6. The colored composition according to claim 1, wherein Ar represents a 5-membered or 6-membered, aromatic ring or saturated heterocyclic ring, each of which is substituted by at least one substituent selected from the group consisting of an alkyl group, an alkoxy group, an aryl group and a substituted amino group.

7. The colored composition according to claim 1, wherein Ar represents a benzene ring, a naphthalene ring, a pyrrole ring, an indole ring, a pyridine ring, a quinoline ring, a pyrazine ring, a quinoxaline ring, a thiazole ring, a thiazoline ring, an oxazole ring, an oxazoline ring, an imidazole ring, an imidazoline ring, a pyrrolidine ring, a tetrahydrofuran ring or a tetrahydrothiophene ring, each of which is substituted by at least one substituent selected from the group consisting of an alkyl group, an alkoxy group, an aryl group and a substituted amino group.

8. The colored composition according to claim 1, wherein Ar represents a benzene ring, a pyrrole ring or an indole ring, each of which is substituted by an alkylamino group having from 6 to 30 carbon atoms in its alkyl moiety.

9. The colored composition according to claim 1, wherein a viscosity of the colored composition at 20° C. is from 0.01 mPa·s to 10 mPa·s.

10. The colored composition according to claim 1, which is used for production of an optical shutter layer of a display device that operates on the principle of electrowetting.

11. The colored composition according to claim 1, which is used for production of a color filter of a display device that operates on the principle of electrophoresis.

12. The colored composition according to claim 1, wherein the non-polar solvent comprises an aliphatic hydrocarbon solvent having from 6 to 30 carbon atoms.

13. The colored composition according to claim 1, wherein the non-polar solvent comprises at least one selected from the group consisting of n-decane, n-dodecane, n-tetradecane and n-hexadecane.

14. The colored composition according to claim 1, wherein a content of the pyrazolone methine dye is 10% by mass or higher with respect to the total mass of the colored composition.

15. An image display structure comprising:
a hydrophobic polymer layer having a hydrophobic surface;
an oil layer arranged to contact the surface of the hydrophobic polymer layer and formed using the colored composition of claim 1; and
a hydrophilic liquid layer arranged to contact the oil layer.
